(19) United States
(12) Patent Application Publication
(10) Pub. No.: US 2026/0057431 A1
(43) Pub. Date: Feb. 26, 2026

(54) METHODS AND SYSTEMS FOR GENERATING PERSONALIZED RECOMMENDATIONS

(71) Applicant: Mastercard International Incorporated, Purchase, NY (US)

(72) Inventors: Amrita Kundu, Siliguri (IN); Debasmita Das, Kolkata (IN); Karl Cheng, Singapore (SG); Nuri Vinod Purswani Ramchandani, Singapore (SG); Wah Xinyan, Singapore (SG); Yatin KATYAL, Rohtak (IN)

(21) Appl. No.: 19/307,587

(22) Filed: Aug. 22, 2025

(30) Foreign Application Priority Data
Aug. 22, 2024 (IN) 202441063440

(51) Int. Cl. G06Q 30/0601; G06Q 20/40

(52) U.S. Cl. CPC G06Q 30/0631; G06Q 20/4016; G06Q 30/0643

(57) ABSTRACT

Methods and systems for processing data accumulated from various data sources via user consent for generating personalized recommendations for a user are disclosed. The method performed by a server system includes requesting a user consent from a user for obtaining user-related information from a decentralized data store. The user-related information includes a plurality of data elements. Method includes receiving the user consent from the user. The user consent indicates consent of the user to access one or more data elements from the plurality of data elements stored with the decentralized data store. Method includes accessing the one or more data elements from the decentralized data store and local data associated with the user from a database. Method includes generating a personalized recommendation for the user based, at least in part, on the one or more data elements and the local data.

### TECHNICAL FIELD

The present disclosure relates to data analysis and, more particularly, to electronic methods and complex processing systems for processing data accumulated from various data sources via user consent for generating personalized recommendations for a user, such as a cardholder or a merchant.

### BACKGROUND

With the rapid digitalization of the financial industry, financial institutions have become increasingly interested in understanding their users and their behavior. Understanding user behavior helps such financial institutions in anticipating their consumer's needs and thus help them in curating targeted services and products for their users. These services or products may range from retail to financial services or products. Examples of financial services may include fraud detection, chargeback prediction, money laundering detection, and so on. In various instances, financial institutions may refer to merchants, issuers, acquirers, third-party service providers, payment processors, and so on. Conventionally, to understand user behavior, affinity data or user preference data reflecting user's preferences or interests, transaction histories are collected and analyzed by a financial institution. However, due to the decentralized nature of the financial domain, this affinity or user preference data for each user is often scattered across different stakeholders, including merchants, issuers, acquirers, and other entities across the payment network. Each of these entities typically holds only a partial view of the user's behavior, which hampers the ability to form a comprehensive understanding of individual preferences and needs.

As may be understood, this fragmentation of user data across different stakeholders creates substantial obstacles for the various stakeholders and the users alike. For merchants, especially new or smaller merchants, the lack of access to a vast amount of user data for different users makes it difficult for them to compete with established or bigger merchants. This promotes unfair market conditions and a lack of competitiveness. In some instances, due to poor understanding of user behavior, financial institutions miss opportunities for targeted marketing and service personalization, which are critical for user retention and engagement. Similarly, the poor understanding of user behavior prohibits merchants from providing tailored recommendations for the users, leading to a poor user experience. At the user's end, a lack of personalized experience can diminish the perceived value of services and products offered by the merchant, which may cause a loss to the user.

Conventionally, the various stakeholders have opted to collect user preference data from various third-party data providers known as data brokers. However, the data collected from such data brokers is often collected without the explicit knowledge of the users and can be unreliable as well. Moreover, the said data is often associated with various data privacy concerns as well. As users are increasingly becoming wary of how their personal and financial information is used, businesses must address the concerns of their users. Further, businesses must navigate a complex landscape of legal requirements across different jurisdictions while collecting user preference data, which is also complicated. Since any mishandling of user information can lead to significant reputational damage, eroding user trust, and user loyalty, it becomes essential for financial institutions to navigate these challenges.

Thus, there exists a technological need for technical solutions for generating personalized recommendations for a user with the consent of the said user securely.

### BRIEF SUMMARY

Various embodiments of the present disclosure provide methods and systems for processing data accumulated from various data sources via user consent for generating personalized recommendations for a user.

In an embodiment, a computer-implemented method for generating personalized recommendations for a user is disclosed. The computer-implemented method performed by a server system includes requesting a user consent from a user for obtaining user-related information from a decentralized data store. The user-related information includes a plurality of data elements. The computer-implemented method further includes receiving the user consent from the user. The user consent indicates consent of the user to access one or more data elements from the plurality of data elements stored with the decentralized data store. The computer-implemented method further includes accessing the one or more data elements from the decentralized data store. The computer-implemented method further includes accessing a local data associated with the user from a database associated with the server system. The computer-implemented method further includes generating a personalized recommendation for the user based, at least in part, on the one or more data elements and the local data.

In another embodiment, a server system is disclosed. The server system includes a communication interface and a memory including executable instructions. The server system also includes a processor communicably coupled to the memory. The processor is configured to execute the instructions to cause the server system, at least in part, to request a user consent from a user for obtaining user-related information from a decentralized data store. The user-related information including a plurality of data elements. The server system is further caused to receive the user consent from the user. The user consent indicates consent of the user to access one or more data elements from the plurality of data elements stored with the decentralized data store. The server system is further caused to access the one or more data elements from the decentralized data store. The server system is further caused to access a local data associated with the user from a database associated with the server system. The server system is further caused to generate a personalized recommendation for the user based, at least in part, on the one or more data elements and the local data.

In yet another embodiment, a non-transitory computer-readable storage medium is disclosed. The non-transitory computer-readable storage medium includes computer-executable instructions that, when executed by at least a processor of a server system, cause the server system to perform a method. The method includes requesting a user consent from a user for obtaining user-related information from a decentralized data store. The user-related information includes a plurality of data elements. The method further includes receiving the user consent from the user. The user consent indicates consent of the user to access one or more data elements from the plurality of data elements stored with the decentralized data store. The method further includes accessing the one or more data elements from the decentralized data store. The method further includes accessing a local data associated with the user from a database associated with the server system. The method further includes generating a personalized recommendation for the user based, at least in part, on the one or more data elements and the local data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3 illustrates a block diagram of the process for generating personalized recommendations for a user, in accordance with an embodiment of the present disclosure;

FIG. 4 illustrates a sequence flow diagram for generating personalized recommendations for a user in response to a user consent, in accordance with an embodiment of the present disclosure;

FIG. 5 illustrates a process flow diagram depicting a method for generating personalized recommendations for a user, in accordance with an embodiment of the present disclosure;

FIG. 6 illustrates a process flow diagram depicting a method for generating personalized recommendations for a user, in accordance with another embodiment of the present disclosure;

FIG. 7 illustrates a simplified block diagram of an acquirer server, in accordance with an embodiment of the present disclosure;

FIG. 8 illustrates a simplified block diagram of an issuer server, in accordance with an embodiment of the present disclosure; and

FIG. 9 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, and “buyer”, are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description, generally refers to a seller, a retailer, a purchase location, an organization, or any other entity that is in the business of selling goods or providing services, and it can refer to either a single business location or a chain of business locations of the same entity. In some instances, the term ‘user’ may be used instead of the term ‘merchant’ as well.

The terms “payment network” and “card network” are used interchangeably throughout the description and refer to a network or collection of systems used for the transfer of funds through the use of cash substitutes. Payment networks may use a variety of different protocols and procedures to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to, a savings account, a credit account, a checking account, and a virtual payment account. The financial account may be associated with an entity, such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, these terms refer to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, user devices, and computer program products for generating personalized recommendations for a user with user consent.

As described earlier, there are multiple challenges in understanding user behavior due to the data fragmentation across various stakeholders, including merchants, issuers, acquirers, and other entities across the payment network. This fragmentation of user data across different stakeholders creates substantial obstacles for the various stakeholders and the users alike. Generally, these stakeholders collect user preference data from various third-party data providers known as data brokers. However, this data is often collected without the explicit knowledge or consent of the users. Moreover, the said data is often associated with various data privacy concerns as well. As users are increasingly becoming wary of how their personal and financial information is used, businesses must address the concerns of their users. Further, businesses must navigate a complex landscape of legal requirements across different jurisdictions while collecting user preference data, which is also complicated.

To address the shortcomings of the various conventional techniques, a novel method for accumulating user-related data from various data sources via user consent for generating personalized recommendations for a user such as a cardholder or a merchant is provided. In particular, the method performed by a server system may include requesting user consent from a user. Here, the user consent may refer to explicit permission from the user allowing the server system to access a decentralized data store associated with the user. In an instance, the decentralized data store may include user-related information collected from one or more data sources.

In an instance, the user-related information stored on the decentralized data store may be collected and stored from different data sources into one or more data elements. Each data element can correspond to either a different data type, a different data source, and/or a combination thereof. Since the user-related information represents one or more data elements, each of which is separately stored within the decentralized data stores, the privacy of the user is maintained. In some instances, each of the one or more data elements may be stored in separate data units within the decentralized data store. Further, it noted that each data element, including a piece of unique information related to the user is created privately and protected through one or more encryption techniques in separate data units within the decentralized data store. This division of information into data elements may be performed based on probable data usage (by third parties such as the server system for various applications). These privately encrypted data elements may be accessed by the server system from the separate data units of the decentralized data store after receiving user consent. It is noted that the user is provided with an option for selecting any of these data elements to give his/her consent. In other words, the user can easily select data elements for which he/she wishes to provide their consent and deselect or ignore data elements for which they don't wish to provide their consent. This aspect helps to preserve the privacy and data security of the user-related information of the user. Since the user-related information is split into one or more privately encrypted data elements, they can be quickly accessed by the server system thus improving the speed of the process.

In response to receiving the user consent, the method may include accessing the user-related information from the decentralized data store. Further, the method includes accessing historical transaction data associated with the user from a database associated with the server system. Then, the method includes generating a personalized recommendation for the user based, at least in part, on the user-related information and the historical transaction data.

To that end, the various embodiments of the present disclosure provide multiple advantages and technical effects while addressing technical problems such as how to aggregate fragmented data associated with the user from different users with the consent of the user and how to generate personalized recommendations for the user.

In an embodiment, the server system is configured to request a user consent from a user for obtaining user-related information from a decentralized data store. Herein, the user is one of a cardholder or a merchant, and the local data is historical transaction data associated with the user. Here, the server system is a payment server associated with a payment network. The user-related information includes a plurality of data elements. In an embodiment, for requesting the user consent from the user, the server system is configured to provision a plurality of options on an electronic device associated with the user. Each option of the plurality of options corresponds to each data element of the plurality of data elements. Herein, the user provides consent to allow the server system to access the one or more data elements from the decentralized data store by selecting one or more options corresponding to the one or more data elements.

In another embodiment, for requesting the user consent, the server system is configured to generate a user consent request for the user based, at least in part, on a set of predefined rules. Here, the user consent request includes a list of data requirements that have to be accessed from the decentralized data store. Then, the server system is configured to transmit the user consent request for requesting the user consent from the user to an electronic device associated with the user. Then, the server system is configured to receive the user consent from the user. Here, the user consent indicates consent of the user to access one or more data elements from the plurality of data elements stored with the decentralized data store. Further, the server system is configured to access the one or more data elements from the decentralized data store.

For accessing the one or more data elements, the server system is configured to transmit the user consent, indicating consent of the user to access the one or more data elements, to the decentralized data store. Here, in response to receiving the user consent, the decentralized data store is configured to allow the server system to access the one or more data elements. Furthermore, the server system is configured to access local data associated with the user from a database associated with the server system. Moreover, the server system is configured to generate personalized recommendations for the user based, at least in part, on the one or more data elements and the local data.

In response to the user denying the user consent, the server system is configured to generate the personalized recommendation for the user based, at least in part, on the local data. Further, the server system is configured to receive a transaction authorization request for an ongoing transaction associated with the user. Furthermore, the server system is configured to extract one or more transaction attributes from the transaction authorization request. Moreover, the server system is configured to generate a risk score associated with the ongoing transaction based, at least in part, on the one or more data elements, the local data, and the one or more transaction attributes. In response to determining that the risk score is greater than a risk threshold, the server system is configured to authorize the ongoing transaction. In response to determining that the risk score is at least equal to a risk threshold, the server system is configured to deny the ongoing transaction.

To that end, the various embodiments of the present disclosure provide an approach for accumulating or aggregating user-related information from various data sources with user consent for generating personalized recommendations for the user, such as a cardholder or a merchant. In some instances, the user-related information may be used for determining a risk score associated with an ongoing transaction associated with the user as well. Since the user-related information provides a deeper understanding of the behavior of the user, an accurate risk score can be generated using this information. The said risk score may be used to authenticate or deny the ongoing transaction, thus promoting security in the payment ecosystem.

In a non-limiting implementation, a user A who frequently visits a chain of cafes and shops at various food stores. If a merchant wants to prepare a personalized recommendation, such as offers or deals for the user A, it can only rely on its own limited data. Since each merchant only sees user A's interactions with their specific store and cannot tailor offers that reflect the broader preference of the user A. To avoid this problem, the transaction data of all these merchants can be stored on the decentralized data storage, and upon receiving user consent from user A, any merchant can access this aggregated data. Using the proposed solution, the merchant is capable of utilizing the server system to process data accumulated from various data sources via user consent for generating personalized recommendations for the user A. In other words, the merchant using the present solution can provide personalized recommendations and offers such as discounts on user A's favorite products and bundle offers, in turn improving user experience.

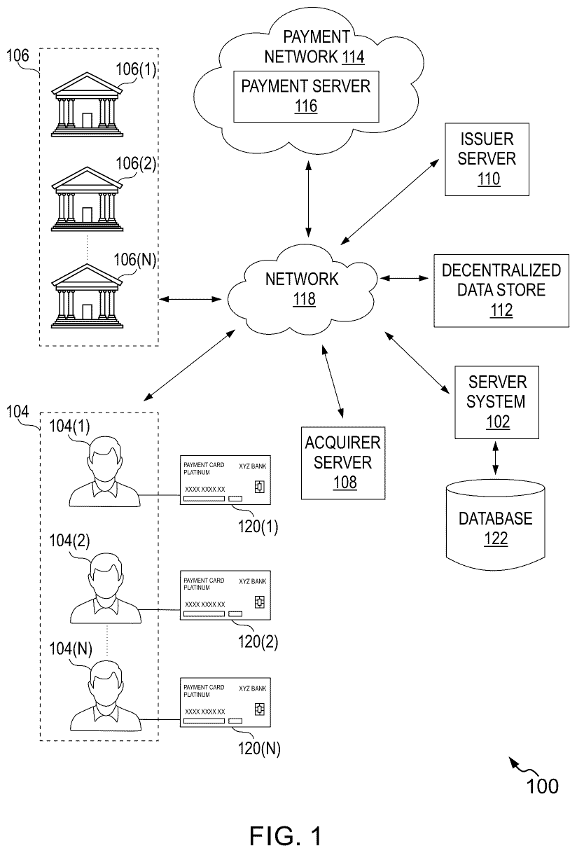

Various embodiments of the present disclosure are described hereinafter with reference to FIG. 1 to FIG. 9.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise, depending on, for example, accumulating data from various data sources via user consent for generating personalized recommendations for a user such as a cardholder or a merchant, and the like.

The environment 100 generally includes a plurality of entities, such as a server system 102, a plurality of cardholders 104(1), 104(2), . . . 104(N) (collectively, referred to as ‘a plurality of cardholders 104’), (‘N’ is a Natural number), a plurality of merchants 106(1), 106(2), . . . 106(N) (collectively, referred to as ‘a plurality of merchants 106’), (‘N’ is a Natural number), an acquirer server 108, an issuer server 110, a decentralized data store 112, and a payment network 114 including a payment server 116, each coupled to, and in communication with (and/or with access to) a network 118. It is noted that the value of N may be different for different entities. The network 118 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 118 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 118 may include multiple different networks, such as a private network made accessible by the server system 102 and a public network (e.g., the Internet, etc.) through which the server system 102, the acquirer server 108, the issuer server 110, the decentralized data store 112, and the payment server 116 may communicate.

In an embodiment, the plurality of cardholders 104 use one or more payment cards 120(1), 120(2), . . . 120(N) (collectively, referred to hereinafter as a plurality of payment cards 120), (‘N’ is a Natural number) respectively to make payment transactions. The cardholder (e.g., the cardholder 104(1)) may be any individual, representative of a corporate entity, a non-profit organization, or any other person who is presenting payment account details during an electronic payment transaction. The cardholder (e.g., the cardholder 104(1)) may have a payment account issued by an issuing bank (not shown in figures) associated with the issuer server 110 (explained later) and may be provided a payment card (e.g., the payment card 120(1)) with financial or other account information encoded onto the payment card (e.g., the payment card 120(1)) such that the cardholder (i.e., the cardholder 104(1)) may use the payment card 120(1) to initiate and complete a payment transaction using a bank account at the issuing bank.

In an example, the plurality of cardholders 104 may use their corresponding electronic devices (not shown in figures) to access a mobile application or a website associated with the decentralized data store 112, issuing bank, or any third-party payment application. In various non-limiting examples, the electronic devices may refer to any electronic devices, such as, but not limited to, Personal Computers (PCs), tablet devices, Personal Digital Assistants (PDAs), voice-activated assistants, Virtual Reality (VR) devices, smartphones, and laptops.

The plurality of merchants 106 may include retail shops, restaurants, supermarkets, or establishments, government and/or private agencies, or any such places equipped with POS terminals, where customers visit to perform financial transactions in exchange for any goods and/or services or any financial transactions.

In one scenario, the plurality of cardholders 104 may use their corresponding payment accounts to conduct payment transactions with the plurality of merchants 106. Moreover, it may be noted that each of the plurality of cardholders 104 may use their corresponding plurality of payment cards 120 differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card 120(2) to perform an offline payment transaction. It is understood that generally, the term “payment transaction” refers to an agreement that is carried out between a buyer and a seller to exchange goods or services in exchange for assets in the form of a payment (e.g., cash, fiat currency, digital asset, cryptographic currency, coins, tokens, etc.). For example, the cardholder 104(1) may enter details of the payment card 120(1) to transfer funds in the form of fiat currency on an e-commerce platform to buy goods. In another instance, each cardholder of the plurality of cardholders 104 (e.g., the cardholder 104(1)) may transact at any merchant from the plurality of merchants 106 (e.g., the merchant 106(1)).

In one embodiment, the plurality of cardholders 104 is associated with the issuer server 110. In one embodiment, the issuer server 110 is associated with a financial institution normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the plurality of merchants 106 is associated with the acquirer server 108. In an embodiment, each merchant (e.g., the merchant 106(1)) is associated with an acquirer server (e.g., the acquirer server 108). In one embodiment, the acquirer server 108 is associated with a financial institution (e.g., a bank) that processes financial transactions. This can be an institution that facilitates the processing of payment transactions for physical stores, merchants (e.g., the merchants 106), or institutions that own platforms that make either online purchases or purchases made via software applications possible (e.g., shopping cart platform providers and in-app payment processing providers). The terms “acquirer”, “acquiring bank”, “acquiring bank”, or “acquirer server”will be used interchangeably herein.

In one embodiment, the payment network 114 may be used by the payment card issuing authorities as a payment interchange network. Examples of the plurality of payment cards 120 include debit cards, credit cards, etc. Similarly, examples of payment interchange networks include, but are not limited to, a payment system interchange network. The payment server 116 associated with the payment network 114 may be responsible for performing various operations for the payment network 114.

In an embodiment, the decentralized data store 112 is a secure and decentralized data storage framework or system. The decentralized data store 112 aims to provide users control over their personal or private data by allowing them to store their data on the decentralized data store 112 rather than relying on centralized services that often collect or manage data. The decentralized data store 112 allows the user (i.e., cardholder 104(1)) to maintain full ownership over their data (called user-related information, described later on). To access this data, user consent is mandatory. This aspect allows the user to maintain their data easily. The term ‘decentralized data store 112’ may be interchangeably referred to as a ‘storage Personal Online Datastore (POD)’.

As explained earlier, there are multiple challenges in understanding user behavior due to data fragmentation across various stakeholders, including merchants 106, issuers 110, acquirers 108, and other entities across the payment network 114.

The above-mentioned technical problem, among other problems described earlier is addressed by one or more embodiments implemented by the server system 102 of the present disclosure. In one embodiment, the server system 102 is configured to perform one or more of the operations described herein.

In one embodiment, the environment 100 may further include a database 122 coupled with the server system 102. In an example, the server system 102 coupled with the database 122 is embodied within the payment server 116. However, in other examples, the server system 102 can be a standalone component (acting as a hub) connected to the acquirer server 108, the issuer server 110, and the decentralized data store 112. The database 122 may be incorporated in the server system 102, or maybe an individual entity connected to the server system 102, or maybe a database stored in cloud storage. In one embodiment, the database 122 may store historical transaction data, various AI or ML models, and other necessary machine instructions required for implementing the various functionalities of the server system 102, such as firmware data, operating system, and the like.

In an embodiment, the server system 102 is configured to request a user consent from a user, such as the cardholder 104(1) or the merchant 106(1). As may be understood, ‘user consent’ refers to the permission given by the user to allow the server system 102 to access the decentralized data store 112 associated with the user. Herein, the decentralized data store includes user-related information collected from one or more data sources. The user-related information may include user preferences, transaction histories, behavioral data, and other types of information that can be used for analytics, decision-making, or generating personalized recommendations for the user.

In an instance, the user-related information stored on the decentralized data store 112 may be collected and stored from different data sources into a plurality of data elements. Examples of the different data sources include fintech services, healthcare services, browsers, tracking services, and so on. Each data element of the plurality of data elements can correspond to either a different data type, a different data source, and/or a combination thereof. Examples of different data types include transaction histories, health or patient records, browser histories from different browsers, location data, travel data, and so on. In an example, a data element can correspond to transaction history with Bank A, another data element can correspond to transaction history with Bank B, and yet another data element can correspond to browser history from Browser X and Browser Y.

Since the user-related information represents one or more data elements, each of which is separately stored within the decentralized data store 112, the privacy of the user is improved. In some instances, each of the one or more data elements may be stored in separate data units within the decentralized data store 112. Further, it noted that each data element, including a piece of unique information related to the user is created privately and protected through one or more encryption techniques in separate data units within the decentralized data store 112. This division of information into data elements may be performed based on probable data usage (by third parties such as the server system 102 for various applications). These privately encrypted data elements may be accessed by the server system 102 from the separate data units of the decentralized data store after receiving user consent. In some instances, to access each data element, an individual user consent linked to each data element may be required. It is noted that the user is provided with a plurality of options for selecting any of these data elements to give his/her consent.

In particular, each option of the plurality of options can correspond to each data element of the plurality of data elements. Herein, the user provides consent to allow any entity such as the server system 102 to access the one or more data elements from the decentralized data store 112 by selecting one or more options corresponding to the one or more data elements. In other words, user can easily select data elements for which he/she wishes to provide their consent and deselect or ignore data elements for which they don't wish to provide their consent (called, partial consent). For instance, if the user is requested by an entity (such as the server system 102) for their user-related information, the user may opt to only provide the data element to their browser history and opt out from sharing their transaction histories with different banks. This aspect helps to preserve the privacy and data security of the user-related information of the user by allowing user to give partial consent. Since the user-related information is split into one or more privately encrypted data elements, they can be quickly accessed by the server system 102 thus improving the speed of the process.

In response to receiving the user consent from the user, the server system 102 is configured to access the user-related information from the decentralized data store 112. As may be appreciated, the requirement for the user's consent ensures that the user is able to designate which data he/she wish to share with the server system 200. Thus enables transparency and privacy preservation for the user. As described earlier, in a scenario where the user wishes to provide partial consent, the user can select one or more options corresponding to the one or more data elements to provide consent for allowing the server system 102 to access the one or more data elements from the decentralized data store 112. To that end, in response to receiving the user consent from the user linked to the one or more data elements, the server system 102 is configured to access the one or more data elements from the decentralized data store 112.

In another embodiment, the server system 102 is configured to access local data associated with the user from the database 122. The term ‘local data’ refers to any data that is stored or owned by the server system 102. For instance, a fast-food chain can collect and store historical transaction data of the cardholders 104 that have performed purchases at their stores. In another example, a hospital can store medical data of its existing and past patients. In a non-limiting implementation in the finance sector, the local data may be historical transaction data. To that end, the server system 102 can be configured to access historical transaction data associated with the user from the database 122. Examples of the historical transaction data may include, but are not limited to, one or more transaction attributes, such as transaction amount, source of funds, such as bank or credit cards, transaction timestamp, transaction channel used for loading funds such as POS terminal or ATM, transaction velocity features, such as count and transaction amount sent in the past ‘x’ number of days to a particular user, transaction location information, external data sources, merchant country, merchant Identifier (ID), cardholder ID, cardholder product, cardholder Permanent Account Number (PAN), MCC, merchant location data or merchant co-ordinates, merchant industry, merchant super industry, ticket price, and other transaction-related data. It is noted that the historical transaction data is associated with an entity or financial institution operating the server system 200. In other words, the information provided by the user-related information and the historical transaction data are distinct.

Then, the server system 102 is configured to generate a personalized recommendation for the user based, at least in part, on the user-related information and the local data. In particular, the server system 102 is configured to generate the personalized recommendation for the user based, at least in part, on the one or more data elements from the user-related information and the local data (such as the historical transaction data). In an example, the various AI or ML models stored in the database 122 may be utilized by the server system 102 for generating the personalized recommendation.

In an exemplary scenario, user A frequently visits a chain of cafes and shops at various food stores. Then, each merchant only sees user A's interactions with their specific store and cannot tailor offers that reflect the broader preference of the user A. To avoid this problem, the transaction data of all these merchants can be stored on the decentralized data store 112, and upon receiving user consent from user A, any merchant can access this aggregated data to provide personalized recommendations and offers such as discounts on user A's favorite products and bundle offers, in turn improving user experience.

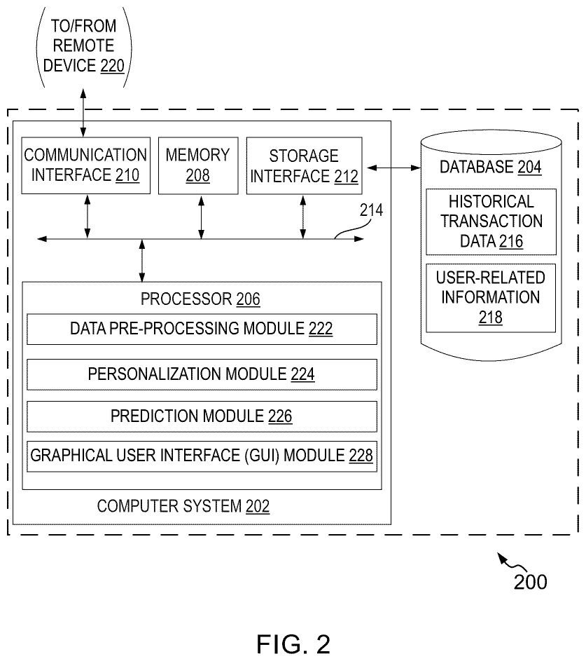

Thereafter, the server system 102 may be configured to perform other operations as well, these operations, along with the operations described earlier and explained further in detail with reference to FIG. 2.

It should be understood that the server system 102 is a separate part of the environment 100 and may operate apart from (but still in communication with, for example, via the network 118) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 118, which may be specifically configured, via executable instructions, to perform steps as described herein, and/or embodied in at least one non-transitory computer-readable media.

It is pertinent to note that the various embodiments of the present disclosure have been described herein with respect to examples from the financial domain, and it should be noted that the various embodiments of the present disclosure can be applied to a wide variety of applications as well and the same will be covered within the scope of the present disclosure as well. To that end, the various embodiments of the present disclosure apply to various applications as well.

FIG. 2 illustrates a simplified block diagram of a server system 200, in accordance with an embodiment of the present disclosure. It is noted that the server system 200 is identical to the server system 102 of FIG. 1. In one embodiment, the server system 200 is a part of the payment network 114 or integrated within the payment server 116. In some embodiments, the server system 200 is embodied as a cloud-based and/or Software as a Service (SaaS) based architecture.

The server system 200 includes a computer system 202 and a database 204. It is noted that the database 204 is identical to the database 122 of FIG. 1. The computer system 202 includes at least one processor 206 for executing instructions, a memory 208, a communication interface 210, a user interface, and a storage interface 212 that communicate with each other via a bus 214.

In some embodiments, the database 204 is integrated into the computer system 202. For example, the computer system 202 may include one or more hard disk drives as the database 204. The user interface is any component capable of providing an administrator (not shown) of the server system 200, the ability to interact with the server system 200. This user interface may be a GUI or Human Machine Interface (HMI) that can be used by the administrator to configure the various operational parameters of the server system 200. The storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store historical transaction data 216, user-related information 218, and so on. Herein, the historical transaction data 216 is an example of the local data that is available to the server system 200. It is noted that the local data may vary according to different applications. In some instances, the database 204 includes various AI/ML models and tools for generating predictions and recommendations as well.

The processor 206 includes suitable logic, circuitry, and/or interfaces to execute operations for generating personalized recommendations and risk scores for a user such as the cardholder 104(1) or the merchant 106(1). In other words, the processor 206 includes suitable logic, circuitry, and/or interfaces to execute operations for the machine learning models for generating personalized recommendations and risk scores for the user (i.e., the cardholder 104(1) or the merchant 106(1). Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 220) such as the issuer server 110, the acquirer server 108, the decentralized data store 112, the payment server 116, or communicating with any entity connected to the network 118 (as shown in FIG. 1).

It is noted that the server system 200, as illustrated and hereinafter described, is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 222, a personalization module 224, a prediction module 226, and a Graphical User Interface (GUI) module 228. It should be noted that components, described herein, such as the data pre-processing module 222, the personalization module 224, the prediction module 226, and the GUI module 228 can be configured in a variety of ways, including electronic circuitries, digital arithmetic, and logic blocks, and memory systems in combination with software, firmware, and embedded technologies such that they are communicably coupled with each other.

In an embodiment, the data pre-processing module 222 includes suitable logic and/or interfaces for generating a user consent request for the user (i.e., the cardholder 104(1) or the merchant 106(1)). In various examples, the user consent request includes a list of requirements, instructions, or parameters required for generating a personalized recommendation or any other prediction by the server system 200. In an instance, the list of requirements, instructions, or parameters may be defined based on a set of predefined rules. The predefined rules may be configured by an administrator (not shown) of the server system 200. In other words, the data pre-processing module 222 is configured to generate the user consent request for the user (i.e., the cardholder 104(1) or the merchant 106(1)) based, at least in part, on the set of predefined rules. The user consent request includes a list of data requirements that have to be accessed from the decentralized data store. The list of data requirements may indicate a list of data elements for which consent has to be requested from the user.

Then, the data pre-processing module 222 is configured to transmit the user consent request to an electronic device associated with the user (i.e., the cardholder 104(1) or the merchant 106(1)) to request the user (i.e., the cardholder 104(1) or the merchant 106(1)) for their consent. Upon receiving the user consent request, the user (i.e., the cardholder 104(1) or the merchant 106(1)) may either accept or deny the request. If the request is rejected, then the process is terminated and the personalization module 224 and the prediction module 226 may generate their corresponding recommendations or predictions based on the internally available data (i.e., the local data such as the historical transaction data 216). In other words, in response to the user (i.e., the cardholder 104(1) or the merchant 106(1)) denying the user consent, the data pre-processing module 222 generates the personalized recommendation for the user (i.e., the cardholder 104(1) or the merchant 106(1)) based, at least in part, on the local data (such as the historical transaction data 216).

However, if the request is accepted, the electronic device of the user (i.e., the cardholder 104(1) or the merchant 106(1)), transmits the user consent to the decentralized data store 112. In particular, the data pre-processing module 222 is configured to provision a plurality of options on the electronic device associated with the user (i.e., the cardholder 104(1) or the merchant 106(1)). Each option of the plurality of options corresponds to each data element of the plurality of data elements. The data pre-processing module 222 may utilize the GUI module 228 for provisioning the plurality of options. The user provides consent to allow the data pre-processing module 222 to access the one or more data elements from the decentralized data store 112 by selecting one or more options corresponding to the one or more data elements. It is noted that one or more data elements might be a subset of the requested data elements from the list of data elements generated based on the list of data requirements. In other words, the user (i.e., the cardholder 104(1) or the merchant 106(1)) may provide a partial consent to the server system 200. Alternatively, the one or more data elements may include all data elements from the list of data elements, when the user (i.e., the cardholder 104(1) or the merchant 106(1)) provides complete consent.

In response to receiving the user consent, the decentralized data store 112 is configured to allow the data pre-processing module 222 to access the user-related information 218 from the decentralized data store 112. As described earlier, the user-related information 218 includes user preferences, transaction histories, behavioral data, and other types of information that can be used for analytics, decision-making, or generating personalized recommendations for the user (i.e., the cardholder 104(1) or the merchant 106(1)). In particular, the data pre-processing module 222 transmits the user consent indicating consent of the user (i.e., the cardholder 104(1) or the merchant 106(1)) to access the one or more data elements to the decentralized data store 112. In response to receiving the user consent, the decentralized data store 112 is configured to allow the data pre-processing module 222 to access the one or more data elements.

Then, the data pre-processing module 222 is configured to access local data associated with the user (i.e., the cardholder 104(1) or the merchant 106(1)) from database 204. In a non-limiting implementation, the data pre-processing module 222 accesses historical transaction data 216 (i.e., the local data) associated with the user from the database 204. The historical transaction data 216 includes, but is not limited to, one or more transaction attributes, such as transaction amount, source of funds, such as bank or credit cards, transaction timestamp, transaction channel used for loading funds such as POS terminal or ATM, transaction velocity features, such as count and transaction amount sent in the past ‘x’ number of days to a particular user, transaction location information, external data sources, merchant country, merchant Identifier (ID), cardholder ID, cardholder product, cardholder Permanent Account Number (PAN), MCC, merchant location data or merchant co-ordinates, merchant industry, merchant super industry, ticket price, and other transaction-related data. It is noted that the historical transaction data is associated with an entity or financial institution operating the server system 200. In other words, the information provided by the user-related information 218 and the historical transaction data 216 are distinct. In particular, the one or more data elements from user-related information 218 provide a holistic view of the behavior or preferences of the user (i.e., the cardholder 104(1) or the merchant 106(1)).

Upon accessing the user-related information 218 and the local data, i.e., the historical transaction data 216, the data pre-processing module 222 is configured to aggregate them by performing various data aggregation techniques. It is noted that data aggregation techniques are well known in the art, therefore they are not described herein for the sake of brevity.

In an embodiment, the personalization module 224 includes suitable logic and/or interfaces for generating a personalized recommendation for the user (i.e., the cardholder 104(1) or the merchant 106(1)) based, at least in part, on the user-related information 218 and the local data. In particular, the personalization module 224 generates the personalized recommendation for the user (i.e., the cardholder 104(1) or the merchant 106(1)) based, at least in part, on the one or more data elements and the local data (or the historical transaction data 216). In an example, an AI or ML model may be utilized by the personalization module 224 for generating the personalized recommendation for the user (i.e., the cardholder 104(1) or the merchant 106(1)). In an alternative scenario, if the user consent is denied, then the personalization module 224 generates the personalized recommendation for the user (i.e., the cardholder 104(1) or the merchant 106(1)) based, at least in part, on only the local data.

In an embodiment, the prediction module 226 includes suitable logic and/or interfaces for receiving a transaction authorization request for an ongoing transaction associated with the user. It is noted that in this embodiment, the user is a cardholder such as cardholder 104(1) performing the ongoing transaction with a merchant such as merchant 106(1). Then, the prediction module 226 is configured to extract one or more transaction attributes from the transaction authorization request. It is noted that examples of the one or more attributes include but are not limited to transaction amount, source of funds, such as bank or credit cards, transaction timestamp, transaction channel used for loading funds such as POS terminal or ATM, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

Then, the prediction module 226 is configured to generate a risk score associated with the ongoing transaction based, at least in part, on the one or more data elements from the user-related information 218, the local data, and one or more transaction attributes. In particular, an AI or ML model (such as a classification model) may be utilized by the prediction module 226 for generating the said risk score. Now, in response to determining that the risk score is at least equal to a risk threshold, the prediction module 226 denies the ongoing transaction. In an instance, the risk threshold may be predefined by the administrator. Alternatively, if the risk score is lower than the risk threshold, the prediction module 226 authorizes the ongoing transaction. In some instances, the risk score may be shared with the issuer for authorizing or denying the ongoing transaction.

In an exemplary scenario, user B uses multiple financial services, including online banking, investment applications, and credit cards with different providers. Then, user preference data related to each of these services is fragmented and won't be available in one place to another financial institution. In other words, each financial service provider will only have a limited view of user B's financial activities, making it difficult to detect unusual patterns or potential fraud. To avoid this problem, the transaction data can be stored on the decentralized data storage 112, and upon receiving user consent from user B, the financial institutions will get a comprehensive view of the user's financial activities. This can enable these institutions to detect anomalies and potential fraud effectively by analyzing the complete financial behavior of user B.

In an embodiment, the GUI module 228 includes suitable logic and/or interfaces for generating at least one GUI or visualization of the personalized recommendation or the risk score on a display associated with the electronic device of the user 104(1) or merchant 106(1).

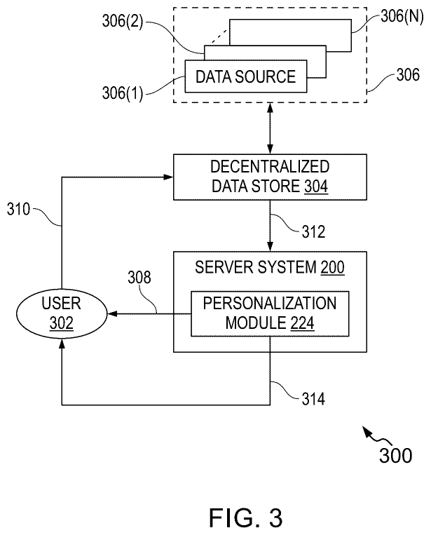

FIG. 3 illustrates a block diagram of the process for generating personalized recommendations for a user 302, in accordance with an embodiment of the present disclosure. It is noted that decentralized data store 304 of FIG. 3 is identical to the decentralized data store 112 of FIG. 1.

In an implementation, a financial institution can utilize the server system 200 to generate a personalized recommendation or a risk score for the user 302. In some instances, the user 302 may be any of the cardholders 104 or the merchants 106. At the onset, the server system 200 may request the user 302 for their user consent. In particular, a user consent request (see, 308 can be shared by the server system 200 with the user 302. The user consent request (see, 308) may include instructions or requirements of the server system 200. These instructions or requirements describe the information required by the server system 200 from the decentralized data store 304 associated with the user 302. The decentralized data store is capable of collecting and recording user-related information 218 from the one or more data sources 306(1), 306(2), . . . , 306(N), where N is a non-zero number (hereinafter, interchangeably referred to as one or more data sources 306). In particular, each user has a decentralized data store 304 where their financial preferences, transaction history, spending habits, etc., among other relevant behavioral information, may be stored. This user-related information 218 is generally stored in various data formats including. but not limited to, JavaScript Object Notation (JSON), eXtensible Markup Language (XML), Comma-Separated Values (CSV), and finance-specific formats such as Open Financial Exchange (OFX), Quicken Interchange Format (QIF), and so on. In some instances, the user-related information 218 is encrypted using various encryption techniques such as Advanced Encryption Standard-256 (AES-256) to ensure data security and privacy. Examples of the one or more data sources 306 include, but are not limited to, financial institutions, healthcare institutions, digital marketing and advertising institutions, video streaming services, fitness tracking services, and so on. In some instances, the scope of the user-related information 218 can be greater than the requirements of the server system 200, therefore the user consent request allows the server system 200 to define the required data for understanding the behavior of the user 302.

For example, the decentralized data store 304 may store user browser history, purchase history for different websites, tracking information from video streaming services, fitness tracking information, transaction histories with different payment cards 120, and so on. In a particular instance, the user consent may not be required for the tracking information from video streaming services for understanding the user behavior, thus the same may not be requested by the instructions within the user consent request. In an instance, the display of a GUI may be facilitated by the server system 200 on the display of an electronic device associated with the server system 200 for allowing the user 302 to grant or revoke consent for accessing their data. Further, detailed logs of user consent may be maintained, including scope, purpose, and duration of access to the user-related information 218. Furthermore, the decentralized data store 304 may also ensure compliance with data protection regulations as well.

The user 302 may give their consent to the decentralized data store 304 (see, 310). In an instance, the user 302, via their consent may define which data elements from the plurality of data elements can be accessed by the server system 200. This aspect allows the user 302 to control what data can or cannot be accessed by a third party such as the server system 200. In response to receiving the user consent (see, 310), the decentralized data store 304 transmits the user-related information 218 (i.e., the selected one or more data elements) allowed by the user consent (see, 310) to the server system 200 (see, 312).

Upon receiving the one or more data elements from the user-related information 218, the server system 200 utilizes the personalization module 224 to generate a personalized recommendation or a risk score for the user 302. This process has been described earlier, therefore the same is not explained again for the sake of brevity. In some instances, AI or ML driven recommendations for offering tailored financial products and services may be generated by the personalization module 224 based on the user-related information 218. In another instance, budgeting tools, expense tracking, and financial goal-setting-related services may also be offered based on the user-related information 218. In yet another instance, personalized notifications and insights to improve user engagement may also be generated using the user-related information 218. Additionally, predictive models for financial behavior analysis, risk assessment, and product recommendations may also be used by the personalization module 224.

Then, the server system 200 transmits the personalized recommendation or the risk score to the user 302 (see, 314). In some instances, the GUI module 228 may generate interactive dashboards and visualizations for the users and organizations to gain insights from the user-related information 218.

In an exemplary scenario, user C uses multiple financial applications to manage their budget, investments, and savings. Such that each app holds separate data on user C's financial activities. In such a scenario, user C will fail to obtain a holistic view of their financial health due to the data being scattered or fragmented across different platforms. To avoid this problem, the transaction data can be stored on the decentralized data storage 304, and upon receiving user consent from user C, a financial advisory service can access the complete financial picture of user C, thus allowing the service to provide comprehensive advice or recommendation for managing their investments, optimizing their savings, and improving their budget.

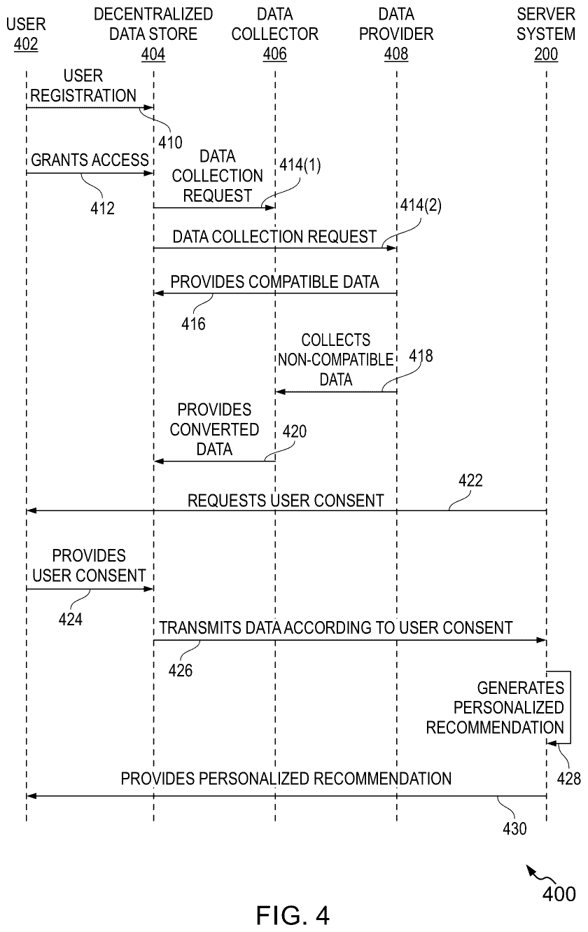

FIG. 4 illustrates a sequence flow diagram 400 for generating personalized recommendations for a user 402 in response to a user consent, in accordance with an embodiment of the present disclosure.

The sequence of operations of the sequence flow diagram 400 may not necessarily be executed in the same order as they are presented. Further, one or more operations may be grouped together and performed in the form of a single step, or one operation may have several sub-steps that may be performed in parallel or in a sequential manner. The sequence flow diagram 400 includes various entities such as the user 402, a decentralized data store 404, a data collector 406, a data provider 408, and the server system 200. It is noted that the user 402 of FIG. 4 is identical to user 302 of FIG. 3 and the decentralized data store 404 of FIG. 4 is identical to either decentralized data store 112 of FIG. 1 or decentralized data store 304 of FIG. 3.

In an embodiment, the data collector 406 refers to an entity or system, i.e., responsible for gathering user-related information (i.e., user-related information 218) from various sources (i.e., the one or more data sources 306). As described earlier, the user-related information 218 may include information related to various activities, transactions, or interactions involving the users. The data collector 406 is responsible for collecting/recording and storing the user-related information 218 within the decentralized data store 404, ensuring that the user-related information 218 is accurate, up-to-date, and relevant to the needs of the server system 200. The user-related information 218 collected by the data collector 406 may include user preferences, transaction histories, behavioral data, and other types of information that can be used for analytics, decision-making, or generating personalized recommendations for the users. Examples of data collector 406 include, but are not limited to, E-commerce platforms, fitness trackers, banking applications, browsers, and so on.

In an embodiment, the data provider 408 refers to an entity or system, i.e., responsible for providing the user-related information 218 to the data collector 406. As may be understood, while the data collector 406 collects the user-related information 218, the data provider 408 facilitates access to this user-related information 218 by other stakeholders, such as merchants 106, service providers, or analytics systems that require the data for various purposes. The data provider 408 is responsible for managing access permissions, ensuring that user-related information 218 is shared securely and that privacy and legal requirements are met. The data provider 408 controls who can access the user-related information 218, what data can be accessed, and under what conditions, thereby playing a critical role in maintaining the integrity and confidentiality of the data. Examples of the data provider 408 include but are not limited to financial institutions, healthcare providers, marketing and advertising businesses, and so on.

As illustrated in FIG. 4, at operation 410, the user 402 may register an account with the decentralized data store 404. As described earlier, the decentralized data store 404 is a secure, user-controlled repository for the user's personal data, preferences, and transaction history, which can be accessed and managed by the user 402 across various platforms and services. The registration process may be initiated by the user 402 via a designated interface such as a web portal, mobile application, or an Application Programming Interface (API) associated with the decentralized data store provider. During registration, the user 402 may be prompted to provide information such as a username, an email address, a phone number, security credentials such as a password, or a biometric template for authentication purposes. Further, the user 402 may be prompted with relevant information for managing the user consent and permissions associated with different data associated with the user. The process of obtaining or collecting this data is described later on. Upon successful registration, a decentralized data store 404 associated with the user 402 is created by the decentralized data store provider.

At operation 412, the user 402 may grant access to the decentralized data store 404 for collecting the user-related information 218 from the one or more data sources. In particular, the user 402 may allow the decentralized data store 404 to collect the user-related information from the one or more data sources 306.

At operation 414(1), the decentralized data store 404 transmits a data collection request to the data collector 406 and at operation 414(2), the decentralized data store 404 transmits a data collection request to the data provider 408. In particular, the data collection request may include specific instructions for collecting the user-related information 218 for which the user 402 granted access with operation 412.

At operation 416, the data provider 408 provides compatible data to the decentralized data store 404. Herein, the term ‘compatible data’ refers to data in a format or structure that can be integrated into the framework of the decentralized data store 404 without processing or with minor processing.

At operation 418, the data collector 406 collects non-compatible data from the data provider 408. Herein, the term ‘non-compatible data’ refers to data in a format or structure that cannot be directly integrated into the framework of the decentralized data store 404. In other words, the non-compatible data requires processing before integration with the framework of the decentralized data store 404.

At operation 420, the data collector 406 provides converted data to the decentralized data store 404. In particular, the data collector 406 converts the non-compatible data into compatible data, i.e., converted data for the decentralized data store 404. This conversion process may involve transforming, standardizing, or enriching the non-compatible data to ensure it meets the necessary criteria for compatibility with the framework of the decentralized data store 404.

At operation 422, the server system 200 requests user consent from the user 402. More specifically, when an operator associated with the server system 200 such as a merchant (e.g., merchant 106(1)) or a financial institution (e.g., an issuer or acquirer) wishes to generate a personalized recommendation for the user 402, they may utilize the server system 200 to request the user 402 for their consent. This user consent may be requested for the user-related information 218 required for understanding the user behavior by the server system 200.

At operation 424, the user 402 provides user consent to the decentralized data store 404. Upon receiving the request for the user consent, the user 402 can either provide their consent or reject the consent. If the consent is not given, then the sequence flow may stop. In some instances, the user 402 may provide partial consent for a portion of the user-related information 218 as well. For instance, the user 402 can either select all data elements or a subset of data elements from the list of data elements in the list of data requirements.

At operation 426, the decentralized data store 404 transmits the data elements according to the user consent, i.e., the user-related information 218 to the server system 200. Once the user consent is received, the decentralized data store 404 transmits the user-related information 218 for which consent is received to the server system 200. As may be appreciated, in the case of partial consent, the portion of user-related information 218 is indicated by the partial consent shared with the server system 200.

At operation 428, the server system 200 generates a personalized recommendation for the user 402 based, at least in part, on the user-related information 218. Upon receiving the user-related information 218, the server system 200 may utilize Artificial Intelligence (AI) or Machine Learning (ML) models for generating a personalized recommendation for the user 402 based, at least in part, on the received user-related information 218. In some instances, internal data such as historical transaction data 216 associated with the server system 200 may also be used in conjunction with the user-related information 218 for generating the personalized recommendation for the user 402.

At 430, the server system 200 transmits the personalized recommendation to the user 402. In some instances, the server system 200 may facilitate the display of a GUI based on the personalized recommendation on an electronic device associated with the user 402.

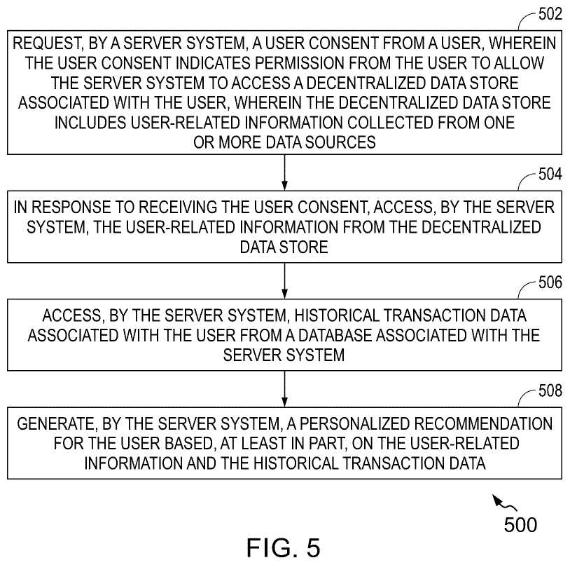

FIG. 5 illustrates a process flow diagram depicting a method 500 for generating personalized recommendations for a user such as a cardholder 104(1) or a merchant 106(1), in accordance with an embodiment of the present disclosure. The method 500 depicted in the flow diagram may be executed by, for example, the server system 200. The sequence of operations of the method 500 may not necessarily be executed in the same order as they are presented. Further, one or more operations may be grouped and performed in the form of a single step, or one operation may have several sub-steps that may be performed in parallel or in a sequential manner. Operations of the method 500, and combinations of operations in the method 500, may be implemented by, for example, hardware, firmware, a processor, circuitry, and/or a different device associated with the execution of software that includes one or more computer program instructions. The plurality of operations is depicted in the process flow of the method 500. The process flow starts at operation 502.

At 502, the method 500 includes requesting, by a server system such as the server system 200, a user consent from a user such as a cardholder 104(1) or a merchant 106(1). Herein, the user consent indicates permission from the user to allow the server system 200 to access a decentralized data store, such as decentralized data store 112 associated with the user such as a cardholder 104(1) or a merchant 106(1). It is noted that the decentralized data store includes user-related information, such as user-related information 218 collected from one or more data sources 306. The user-related information 218 may also be called affinity or user preference data.

At 504, the method 500 includes in response to receiving the user consent, accessing, by the server system 200, the user-related information 218 from the decentralized data store 112.

At 506, the method 500 includes accessing, by the server system 200, historical transaction data such as historical transaction data 216 associated with the user such as a cardholder 104(1) or a merchant 106(1) from a database such as database 204 associated with the server system 200.

At 508, the method 500 includes generating, by the server system 200, a personalized recommendation for the user such as a cardholder 104(1) or a merchant 106(1) based, at least in part, on the user-related information 218 and the historical transaction data 216.

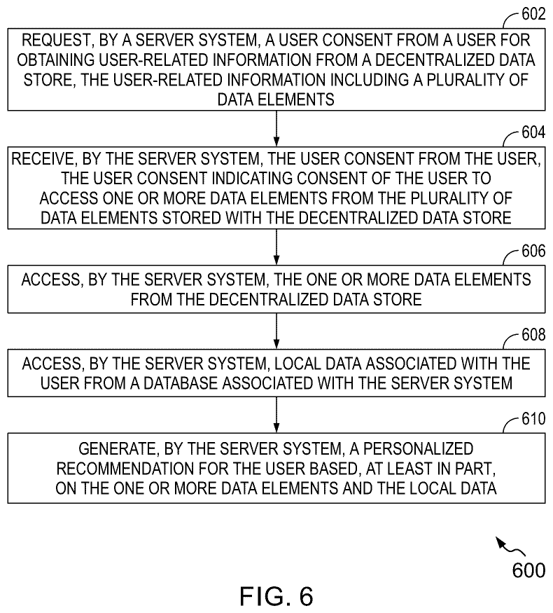

FIG. 6 illustrates a process flow diagram depicting a method 600 for generating personalized recommendations for a user such as a cardholder 104(1) or a merchant 106(1), in accordance with another embodiment of the present disclosure. The method 600 depicted in the flow diagram may be executed by, for example, the server system 200. The sequence of operations of the method 600 may not necessarily be executed in the same order as they are presented. Further, one or more operations may be grouped and performed in the form of a single step, or one operation may have several sub-steps that may be performed in parallel or in a sequential manner. Operations of the method 600, and combinations of operations in the method 600, may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes requesting, by a server system such as the server system 200, a user consent from a user such as a cardholder 104(1) or a merchant 106(1) for obtaining user-related information such as the user-related information 218 from a decentralized data store such as decentralized data store 112. The user-related information 218 includes a plurality of data elements.

At 604, the method 600 includes receiving, by the server system 200, the user consent from the user such as a cardholder 104(1) or a merchant 106(1). The user consent indicates consent of the user such as a cardholder 104(1) or a merchant 106(1) to access one or more data elements from the plurality of data elements stored with the decentralized data store 112.

At 606, the method 600 includes accessing, by the server system 200, the one or more data elements from the decentralized data store 112.

At 608, the method 600 includes accessing, by the server system 200, local data (such as historical transaction data 216) associated with the user such as a cardholder 104(1) or a merchant 106(1) from a database such as database 204 associated with the server system 200.

At 610, the method 600 includes generating, by the server system 200, a personalized recommendation for the user such as a cardholder 104(1) or a merchant 106(1) based, at least in part, on the one or more data elements and the local data.

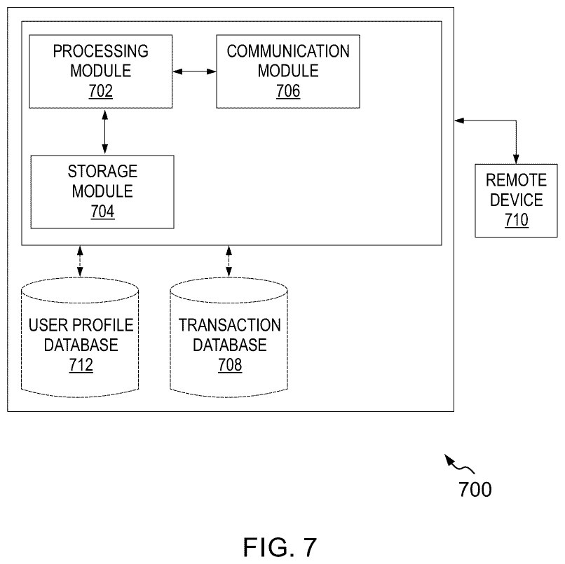

FIG. 7 illustrates a simplified block diagram of the acquirer server 700, in accordance with an embodiment of the present disclosure. The acquirer server 700 is an example of the acquirer server 108 of FIG. 1. The acquirer server 700 is associated with an acquirer bank/acquirer, in which a merchant may have an account, which provides a payment card. The acquirer server 700 includes a processing module 702 operatively coupled to a storage module 704 and a communication module 706. The components of the acquirer server 700 provided herein may not be exhaustive, and the acquirer server 700 may include more or fewer components than those depicted in FIG. 7. Further, two or more components may be embodied in one single component, and/or one component may be configured using multiple sub-components to achieve the desired functionalities. Some components of the acquirer server 700 may be configured using hardware elements, software elements, firmware elements, and/or a combination thereof.

The storage module 704 is configured to store machine-executable instructions to be accessed by the processing module 702. Additionally, the storage module 704 stores information related to the contact information of the merchant, bank account number, availability of funds in the account, payment card details, transaction details, and/or the like. Further, the storage module 704 is configured to store payment transactions.

In one embodiment, the acquirer server 700 is configured to store profile data (e.g., an account balance, a credit line, details of the plurality of merchants 106, account identification information, and a payment card number) in a transaction database 708. The details of the plurality of merchants 106 may include, but are not limited to, name, age, gender, physical attributes, location, registered contact number, family information, alternate contact number, registered e-mail address, etc.

The processing module 702 is configured to communicate with one or more remote devices such as a remote device 710 using the communication module 706 over a network such as the network 118 of FIG. 1. The examples of the remote device 710 include the server system 102, the payment server 116, the issuer server 110, or other computing systems of the acquirer server 700, and the like. The communication module 706 is capable of facilitating such operative communication with the remote devices and cloud servers using Application Program Interface (API) calls. The communication module 706 is configured to receive a payment transaction request performed by the plurality of cardholders 104 via the network 118. The processing module 702 receives payment card information, a payment transaction amount, customer information, and merchant information from the remote device 710 (i.e., the payment server 116). The acquirer server 700 includes a user profile database 712 and the transaction database 708 for storing transaction data. The user profile database 712 may include information about the merchants 106. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

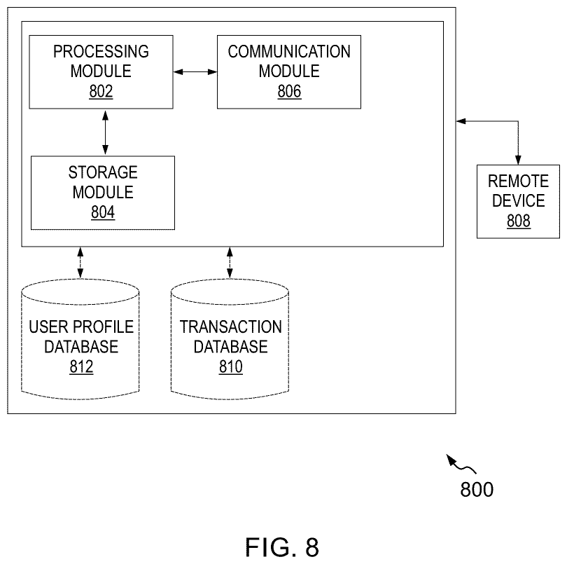

FIG. 8 illustrates a simplified block diagram of an issuer server 800, in accordance with an embodiment of the present disclosure. The issuer server 800 is an example of the issuer server 110 of FIG. 1. The issuer server 800 is associated with an issuer bank/issuer, in which an account holder (e.g., the plurality of cardholders 104(1)-104(N)) may have an account, which provides a payment card (e.g., the payment cards 120(1)-120(N)). The issuer server 800 includes a processing module 802 operatively coupled to a storage module 804 and a communication module 806. The components of the issuer server 800 provided herein may not be exhaustive, and the issuer server 800 may include more or fewer components than those depicted in FIG. 8. Further, two or more components may be embodied in one single component, and/or one component may be configured using multiple sub-components to achieve the desired functionalities. Some components of the issuer server 800 may be configured using hardware elements, software elements, firmware elements, and/or a combination thereof.

The storage module 804 is configured to store machine-executable instructions to be accessed by the processing module 802. Additionally, the storage module 804 stores information related to the contact information of the cardholders (e.g., the plurality of cardholders 104(1)-104(N)), a bank account number, availability of funds in the account, payment card details, transaction details, payment account details, and/or the like. Further, the storage module 804 is configured to store payment transactions.

In one embodiment, the issuer server 800 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 802 is configured to communicate with one or more remote devices such as a remote device 808 using the communication module 806 over a network such as the network 118 of FIG. 1. Examples of the remote device 808 include the server system 200, the payment server 116, the acquirer server 108 or other computing systems of the issuer server 800. The communication module 806 is capable of facilitating such operative communication with the remote devices and cloud servers using API calls. The communication module 806 is configured to receive a payment transaction request performed by an account holder (e.g., the cardholder 104(1)) via the network 118. The processing module 802 receives payment card information, a payment transaction amount, customer information, and merchant information from the remote device 808 (e.g., the payment server 116). The issuer server 800 includes a transaction database 810 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 800 includes a user profile database 812 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the plurality of cardholders 104.

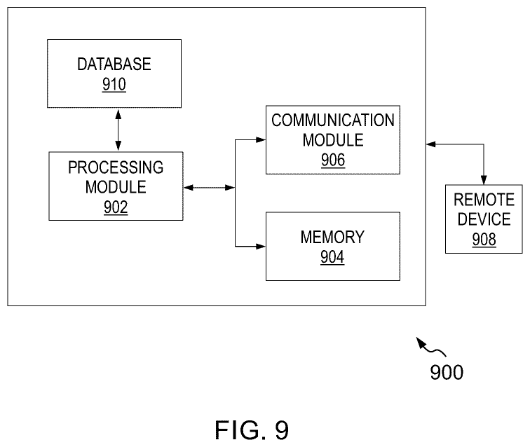

FIG. 9 illustrates a simplified block diagram of the payment server 900, in accordance with an embodiment of the present disclosure. The payment server 900 is an example of the payment server 116 of FIG. 1. The payment server 900 and the server system 200 may use the payment network 114 as a payment interchange network.

The payment server 900 includes a processing module 902 configured to extract programming instructions from a memory 904 to provide various features of the present disclosure. The components of the payment server 900 provided herein may not be exhaustive, and the payment server 900 may include more or fewer components than that depicted in FIG. 9. Further, two or more components may be embodied in one single component, and/or one component may be configured using multiple sub-components to achieve the desired functionalities. Some components of the payment server 900 may be configured using hardware elements, software elements, firmware elements, and/or a combination thereof.

Via a communication module 906, the processing module 902 receives a request from a remote device 908, such as the issuer server 110, the acquirer server 108, or the server system 102. The request may be a request to conduct the payment transaction. The communication may be achieved through API calls, without loss of generality. The payment server 900 includes a database 910. The database 910 also includes transaction processing data such as issuer ID, country code, acquirer ID, and Merchant Identifier (MID), among others.

When the payment server 900 receives a payment transaction request from the acquirer server 108 or a payment terminal (e.g., IoT device), the payment server 900 may route the payment transaction request to an issuer server (e.g., the issuer server 110). The database 910 stores transaction identifiers for identifying transaction details, such as transaction amount, IoT device details, acquirer account information, transaction records, merchant account information, and the like.

In one example embodiment, the acquirer server 108 is configured to send an authorization request message to the payment server 900. The authorization request message includes, but is not limited to, the payment transaction request.

The processing module 902 further sends the payment transaction request to the issuer server 110 for facilitating the payment transactions from the remote device 908. The processing module 902 is further configured to notify the remote device 908 of the transaction status in the form of an authorization response message via the communication module 906. The authorization response message includes, but is not limited to, a payment transaction response received from the issuer server 110. Alternatively, in one embodiment, the processing module 902 is configured to send an authorization response message for declining the payment transaction request, via the communication module 906, to the acquirer server 108. In one embodiment, the processing module 902 executes similar operations performed by the server system 200, however, for the sake of brevity, these operations are not explained herein.

The disclosed method with reference to FIG. 5 and FIG. 6, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations that are different than those that are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
requesting, by a server system, a user consent from a user for obtaining user-related information from a decentralized data store, the user-related information comprising a plurality of data elements;
receiving, by the server system, the user consent from the user, the user consent indicating consent of the user to access one or more data elements from the plurality of data elements stored with the decentralized data store;
accessing, by the server system, the one or more data elements from the decentralized data store;
accessing, by the server system, local data associated with the user from a database associated with the server system; and
generating, by the server system, a personalized recommendation for the user based, at least in part, on the one or more data elements and the local data.

2. The computer-implemented method as claimed in claim 1, wherein requesting the user consent from the user comprises:
provisioning, by the server system, a plurality of options on an electronic device associated with the user, each option of the plurality of options corresponding to each data element of the plurality of data elements,
wherein the user provides consent to allow the server system to access the one or more data elements from the decentralized data store by selecting one or more options corresponding to the one or more data elements.

3. The computer-implemented method as claimed in claim 1, wherein requesting the user consent comprises:
generating, by the server system, a user consent request for the user based, at least in part, on a set of predefined rules, the user consent request comprising a list of data requirements that has to be accessed from the decentralized data store; and
transmitting, by the server system, the user consent request for requesting the user consent from the user to an electronic device associated with the user.

4. The computer-implemented method as claimed in claim 1, wherein accessing the one or more data elements comprises:
transmitting, by the server system, the user consent indicating consent of the user to access the one or more data elements to the decentralized data store, wherein in response to receiving the user consent, the decentralized data store is configured to allow the server system to access the one or more data elements.

5. The computer-implemented method as claimed in claim 1, further comprising:
in response to the user denying the user consent, generating, by the server system, the personalized recommendation for the user based, at least in part, on the local data.

6. The computer-implemented method as claimed in claim 1, further comprising:
receiving, by the server system, a transaction authorization request for an ongoing transaction associated with the user;
extracting, by the server system, one or more transaction attributes from the transaction authorization request;
generating, by the server system, a risk score associated with the ongoing transaction based, at least in part, on the one or more data elements, the local data, and the one or more transaction attributes; and
in response to determining that the risk score is greater than a risk threshold, authorizing, by the server system, the ongoing transaction.

7. The computer-implemented method as claimed in claim 6, further comprising:
in response to determining that the risk score is at least equal to a risk threshold, denying, by the server system, the ongoing transaction.

8. The computer-implemented method as claimed in claim 6, wherein the user is one of a cardholder or a merchant, and the local data is historical transaction data associated with the user.

9. The computer-implemented method as claimed in claim 1, wherein the server system is a payment server associated with a payment network.

10. A server system, comprising:
a communication interface;
a memory comprising executable instructions; and
a processor communicably coupled to the communication interface and the memory, the processor configured to cause the server system to at least:
request a user consent from a user for obtaining user-related information from a decentralized data store, the user-related information comprising a plurality of data elements;
receive the user consent from the user, the user consent indicating consent of the user to access one or more data elements from the plurality of data elements stored with the decentralized data store;
access the one or more data elements from the decentralized data store;
access a local data associated with the user from a database associated with the server system; and
generate a personalized recommendation for the user based, at least in part, on the one or more data elements and the local data.

11. The server system as claimed in claim 10, wherein to request the user consent from the user, the server system is further caused, at least in part, to:
provision a plurality of options on an electronic device associated with the user, each option of the plurality of options corresponding to each data element of the plurality of data elements,
wherein the user provides consent to allow the server system to access the one or more data elements from the decentralized data store by selecting one or more options corresponding to the one or more data elements.

12. The server system as claimed in claim 10, wherein to request the user consent, the server system is further caused, at least in part, to:
generate a user consent request for the user based, at least in part, on a set of predefined rules, the user consent request comprising a list of data requirements that has to be accessed from the decentralized data store; and
transmit the user consent request for requesting the user consent from the user to an electronic device associated with the user.

13. The server system as claimed in claim 10, wherein to access the one or more data elements, the server system is further caused, at least in part, to:
transmit the user consent indicating consent of the user to access the one or more data elements to the decentralized data store, wherein in response to receiving the user consent, the decentralized data store is configured to allow the server system to access the one or more data elements.

14. The server system as claimed in claim 10, wherein the server system is further caused, at least in part, to:
in response to the user denying the user consent, generate the personalized recommendation for the user based, at least in part, on the local data.

15. The server system as claimed in claim 10, wherein the server system is further caused, at least in part, to:
receive a transaction authorization request for an ongoing transaction associated with the user;
extract one or more transaction attributes from the transaction authorization request;
generate a risk score associated with the ongoing transaction based, at least in part, on the one or more data elements, the local data, and the one or more transaction attributes; and
in response to determining that the risk score is greater than a risk threshold, authorize the ongoing transaction.

16. The server system as claimed in claim 15, wherein the server system is further caused, at least in part, to:
in response to determining that the risk score is at least equal to a risk threshold, deny the ongoing transaction.

17. The server system as claimed in claim 15, wherein the user is one of a cardholder or a merchant, and the local data is historical transaction data associated with the user.

18. The server system as claimed in claim 10, wherein the server system is a payment server associated with a payment network.

19. A non-transitory computer-readable storage medium comprising computer-executable instructions that, when executed by at least a processor of a server system, cause the server system to perform a method comprising:
requesting a user consent from a user for obtaining user-related information from a decentralized data store, the user-related information comprising a plurality of data elements;
receiving the user consent from the user, the user consent indicating consent of the user to access one or more data elements from the plurality of data elements stored with the decentralized data store;
accessing the one or more data elements from the decentralized data store;
accessing a local data associated with the user from a database associated with the server system; and
generating a personalized recommendation for the user based, at least in part, on the one or more data elements and the local data.

20. The non-transitory computer-readable storage medium as claimed in claim 19, wherein requesting the user consent from the user comprises:
provisioning a plurality of options on an electronic device associated with the user, each option of the plurality of options corresponding to each data element of the plurality of data elements,
wherein the user provides consent to allow the server system to access the one or more data elements from the decentralized data store by selecting one or more options corresponding to the one or more data elements.
